(19) United States
(12) Patent Application Publication
(10) Pub. No.: US 2026/0152296 A1
(43) Pub. Date: Jun. 4, 2026

(54) ELECTRIC THRUSTER WITH THERMIONIC CATHODE IN OXYGEN-RICH ENVIRONMENT

(71) Applicant: Northrop Grumman Systems Corporation, Falls Church, VA (US)

(72) Inventors: Michael J. Glogowski, Leesburg, VA (US); Valerie Fabienne Marius Josten, Sterling, VA (US)

(21) Appl. No.: 18/966,857

(22) Filed: Dec. 3, 2024

(51) Int. Cl. B64G 1/40; B64G 1/10

(52) U.S. Cl. CPC B64G 1/413; B64G 1/10

(57) ABSTRACT

Electric propulsion systems, including electrostatic ion thrusters, for operation in oxygen containing environments, such as very low Earth orbit, may include an oxygen transport membrane, a cathode, and a thruster. The oxygen transport membrane is used to separate oxygen from other constituents in a feed gas resulting in an oxygen rich gas (or permeate) and an oxygen depleted gas (or retentate). The oxygen depleted gas is routed to the cathode. The oxygen rich feed gas is routed to the thruster, such as a Hall Effect Thruster (HET).

### TECHNICAL FIELD

The present disclosure relates to electric thrusters and methods for operating electric thrusters with a thermionic cathode in oxygen rich environments.

### BACKGROUND

Ion thrusters are a type of electric propulsion system that generates thrust by accelerating ions using electrical energy. Ion thrusters are particularly suitable for spacecraft. Electrostatic ion thrusters, such as Hall-effect thrusters (HET) and gridded ion thrusters (GIT), are used in a variety of spaceflight applications. The HET is more common than the GIT in near Earth orbit applications.

### SUMMARY

The systems and techniques described in the present disclosure provide for electric thrusters and operation of the same using air and other oxygen-rich propellants without the need for a separate gas feed system for the cathode or a power-intensive, radio-frequency cathode for compatibility with a corrosive oxygen environment. The described electric thrusters can use a standard thermionic cathode with oxygen-rich propellants and avoid the design complexity, cost, and higher power requirements associated with alternate approaches. For an air-breathing electric thrusters operating at very low Earth orbit (VLEO) altitudes, the disclosure provides superior characteristics over alternate approaches, by avoiding the extra mass and lifetime limitations of a separate gas feed system and minimizing the amount of power required by the spacecraft to produce thrust to counteract drag at VLEO altitudes.

Various examples of the disclosure include an electric thruster for operation at VLEO having an oxygen transport membrane, a feed gas, a cathode, and a thruster. The oxygen transport membrane has an inlet, an oxygen rich outlet, and an oxygen depleted outlet. The feed gas of the inlet may include oxygen and nitrogen or any type of oxygen-rich gas mixture. The cathode is connected to the oxygen depleted outlet and the thruster is connected to the oxygen rich outlet.

In some examples, the oxygen depleted outlet is positioned downstream of the oxygen rich outlet. In some examples, the oxygen transport membrane is wrapped in a heater element. In some examples, the heater element is configured to raise an operating temperature of the oxygen transport membrane above approximately 500 degree Celsius (° C.). In some examples, the heater element comprises mineral insulated cable heaters. In some examples, the oxygen transport membrane is wrapped in a thermal shield. Additionally, or alternatively, the oxygen transport membrane may include a electronic device configured to establish an electric potential within a range from approximately 1 volt (V) to approximately 5 V (alternatively, approximately 1 Watts (W) to approximately 2 W) across the membrane to facilitate electro-migration of a selected gas constituent.

In some examples, the cathode includes lanthanum hexaboride. In some examples, a depleted gas contains less than 1% oxygen at the cathode. In some examples, the oxygen transport mechanism comprises a ceramic permeable membrane. In some examples, the ceramic is Perovskite ceramic. In some examples, the oxygen transport membrane is connected in series with a second oxygen transport membrane. For example, a first permeate from a first oxygen transport membrane may be fed into a second oxygen transport membrane, providing a second permeate having less oxygen than the first permeate.

Various examples of the disclosure include a compound transport membrane for an ion propulsion system including a stable ionic conductor and a stable electronic conductor within a crystalline ceramic matrix. The compound transport membrane has an input end for receiving a feed gas opposite an output end. The output end has a first orifice configured for connection to a cathode and a second orifice configured for connection to an anode. The first and second orifices are positioned to generate a predetermined pressure gradient, allowing for the compound to permeate across the membrane. In some cases, the first orifice is positioned downstream from the second orifice.

In some examples, the feed gas is atmospheric air that includes approximately one-third oxygen and two-thirds nitrogen. In some examples, the feed gas is a compound gas including oxygen, nitrogen, nitrogen dioxide, and carbon dioxide. In some examples, more than 99 percent of the oxygen within the feed gas permeates across the membrane. In some examples, the compound transport membrane is connected to a second compound transport membrane, and the second compound transport membrane is configured to remove a second compound from the feed gas. In some examples, the compound transport membrane is combined with an ion propulsion system.

Various examples of the disclosure are directed to a method of operating an electric thruster having a thermionic cathode in an oxygen rich environment. The method includes drawing air from the oxygen rich environment into an oxygen transport membrane. The method further includes separating the air, using the oxygen transport membrane, into oxygen rich gas and oxygen depleted gas. The oxygen depleted gas is routed to the thermionic cathode. In some examples, the oxygen rich gas is routed to an HETa. In some examples, the method further includes heating the oxygen transport membrane to at least 500° C.

### BRIEF DESCRIPTION OF THE DRAWINGS

The following detailed description provides various examples in connection with the accompanying drawings.

FIG. 1 is a conceptual diagram illustrating an orbiting satellite.

FIG. 2 is a conceptual diagram illustrating an example oxygen transport membrane (OTM).

FIG. 3 is a conceptual diagram illustrating an OTM separating oxygen from a feed gas.

FIG. 4 is a chart illustrating oxygen flux through an OTM versus a normalized length of a membrane tube.

FIG. 5 is a chart illustrating nitrogen purity for an OTM versus a normalized length of a membrane tube.

FIG. 6 is a chart illustrating oxygen flux versus pressure on the permeate side for an individual element within the OTMs with a radius of 1 millimeter (mm) and wall thickness of 0.1 mm, at 1000° C.

FIG. 7 is a chart illustrating nitrogen purity versus pressure on the permeate side for an individual element within the OMTs with a radius of 1 mm and wall thickness of 0.1 mm, at 1000° C.

FIG. 8 is a conceptual diagram of an example ionic thruster having a single OTM.

FIG. 9 is a conceptual diagram of an example ionic thruster having two OTMs connected in series.

FIG. 10 is a conceptual diagram of an example ionic thruster having a single OTM with a modified flow control scheme.

FIG. 11 is a conceptual diagram of an example ionic thruster having two OTMs connected in series with a modified flow control scheme.

FIG. 12 is a conceptual diagram illustrating a cathode for an ionic thruster.

FIG. 13 is a chart illustrating insert life versus discharge current for cathodes of various lengths.

### DETAILED DESCRIPTION

The most common form of electric propulsion (EP) used currently in spaceflight applications is the electrostatic ion thruster, for which there are two variants: the Hall-effect thruster (HET) and the gridded ion thruster (GIT). The HET is more widely used than the GIT in near Earth orbit applications due to its ideal combination of propellant utilization efficiency and thrust-to-input power ratio. The GIT offers higher propellant utilization but at lower thrust per unit of input power, which equates to longer maneuvering times or larger amounts of on-board spacecraft power. For applications to the outer planets where time plays a smaller role in mission design, the GIT tends to be the preferred choice. The basic operating principle of the electrostatic ion thruster is that it ionizes a gaseous propellant within a discharge chamber through collisions with electrons that are magnetically trapped inside the discharge chamber. The resulting plasma is then accelerated out of the thruster, producing thrust at very high exit velocities, through an electric field that is formed by a set of voltage-biased grids in the case of the gridded ion thruster or formed through a field of swirling electrons in the case of the HET. In both cases, the primary source of the electrons for plume neutralization is from a cathode that emits electrons using a thermionic material, like barium oxide (BaO) or lanthanum hexaboride (LaB₆). In a HET, these emitted electrons also help to sustain the plasma discharge inside the discharge channel in addition to neutralizing the beam of ions being accelerated out of the thruster.

Typically, electrostatic ion thrusters operate on noble gases, like xenon and krypton, at very high purity levels to avoid oxygen poisoning, which can dramatically shorten the life of the thermionic cathode. For example, with the BaO cathode, the purity level may need to be at least 99.995%, while the LaB₆ cathode may provide some relief with its lower purity level requirement of 99%. For new applications of the HET, where oxygen or an oxygen compound is the primary constituent of the propellant, some accommodation may need to be made to achieve oxygen compatibility.

The present disclosure addresses the problem of oxygen compatibility by removing the oxygen from the propellant before it reaches the cathode instead of adding a separate feed system for the cathode or using a more complex and power-hungry alternate cathode design that ingests the oxygen directly. Beyond the electrostatic ion thrusters (HET and GIT), the present disclosure has relevance to other forms of electronic propulsion such as the magneto-plasmadynamic (MPD) thruster, which uses a combination of electromagnetic and electrostatic fields to generate thrust. A magneto-plasma dynamic (MPD) thruster includes a cathode similar to the ones used in the HET and GIT to generate electrons. As such, MPD thrusters would also benefit from having oxygen removed from the propellant before reaching the cathode.

An additional purpose of the present disclosure is a reduction of the costs of production of ion thrusters. The present disclosure avoids the need for a radio frequency (RF) driven cathode, which is more expensive by design and requires an expensive RF generator to produce the RF drive signal. The present disclosure further avoids the added cost of a separate noble gas feed system which includes a composite overwrapped pressure vessel, pressure regulator, pressure transducers, and flow isolation valves. Further, at the system level, the present disclosure requires less power than the alternate cathodes, which equates to fewer solar array cells, less spacecraft power processing electronics, and smaller batteries.

Existing methods for electric thruster operation with corrosive propellants rely on RF energy to either produce the electron current from a cathode for the main plasma discharge within an HET or GIT or to produce the main plasma discharge without the need for a cathode. Both methods are highly inefficient and lead to more power per unit thrust and/or less propellant utilization. For example, current RF cathodes require around 160 W of power to generate 1 Amp of current, which can lead to around 50% more power demand on the spacecraft to operate the thruster. The present disclosure reduces the power requirement to around 15W to 30W per Amp of current, which adds only around 10% more power. This difference in power is significant and can lead to higher costs for spacecraft with RF cathodes, which must add more solar array power and power processing electronics to contend with the extra power. Another example is the RF plasma thruster, which eliminates the need for electrodes and, in principle, is more compatible with corrosive propellants. However, these devices are very inefficient in generating thrust compared to other electric thrusters. For example, the RF plasma thruster typically produces around 15 mN of thrust per kW of input power with xenon, while a HET would produce around 50 mN of thrust per kW of power when using a thermionic cathode (and less if required to use an RF cathode for propellant compatibility reasons). In short, this disclosure enables the use of higher-performance electric thrusters, such as the HET and GIT, with corrosive propellants without the added complexity, power, and cost of plasma generation through RF means.

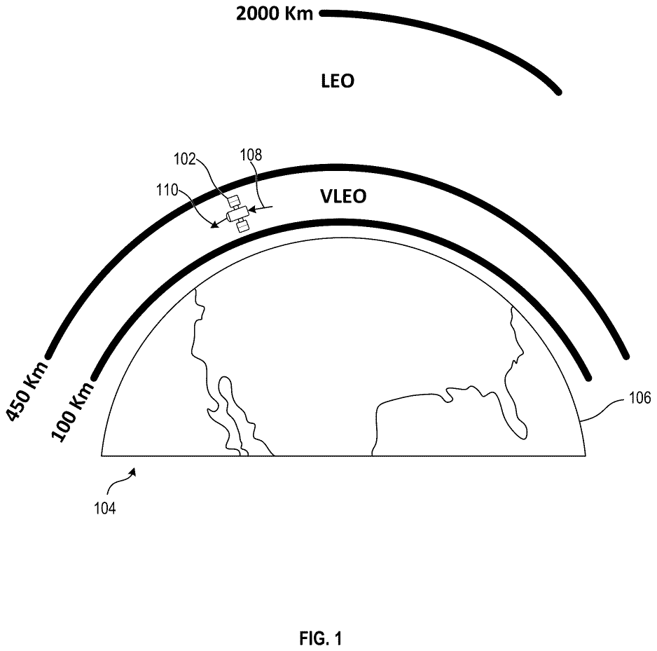

Satellites orbit the Earth at a variety of altitudes, each altitude potentially having different atmospheric conditions. Referring to FIG. 1, satellite 102 is shown orbiting the Earth 104 in a VLEO. VLEO is generally between 100 kilometers (km) and 450 (km) from the surface 106 of the Earth 104, and Low Earth Orbit (LEO) is generally between 450 km and 2000 km from the surface 106 of the Earth 104. Satellite is configured to ingest atmospheric gas 108 and expel an exhaust gas 110. The primary atmospheric constituents at VLEO altitudes are atomic oxygen and diatomic nitrogen. Atomic oxygen, which is reactive and results in highly corrosive effects on components such as the cathode in an electric thruster, accounts for between approximately 40% to approximately 81% of the atmospheric constituents in VLEO for altitudes between 100 km and 250 km.

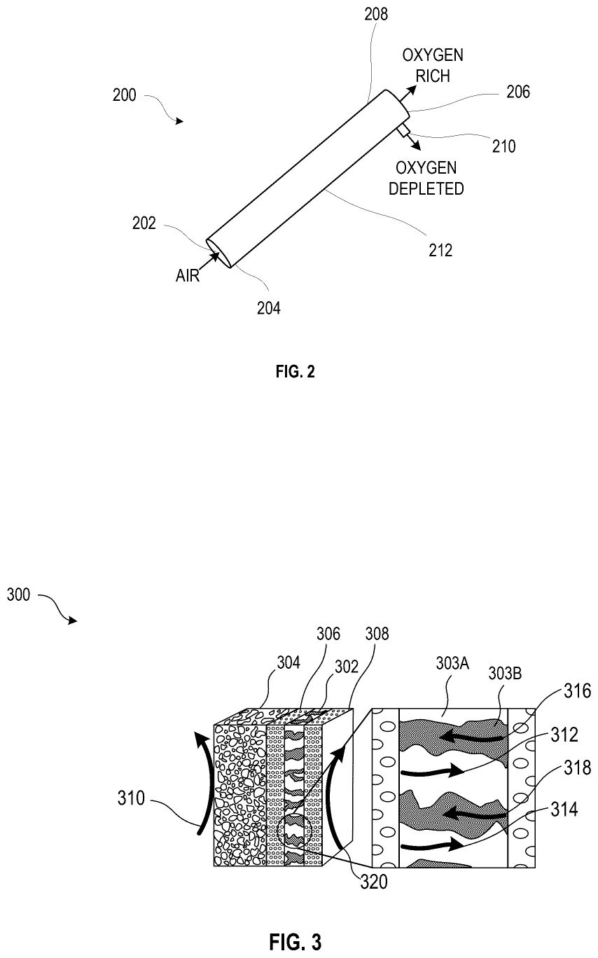

FIG. 2 depicts an example oxygen transfer membrane device 200 (hereinafter, OTM device 200). OTM device 200 includes a tubular configuration composed of one or multiple individual hollow fiber oxygen transport membrane elements. OTM device 200 is configured to separate oxygen from other constituents of air. It should be understood that various membranes can be used in place of an oxygen transfer membrane to separate different gas constituents. Accordingly, a reference to, for example, an outlet for oxygen rich gas might instead be an outlet for a different gas constituent depending on the configuration of the transport membrane. As such, membranes that filter for constituents other than oxygen are within the scope of this disclosure.

OTM device 200 includes an inlet 202 configured to receive a feed gas at a first end 204 and a first outlet port 206 for oxygen rich gas at a second, opposite end 208. A second outlet port 210 for oxygen depleted gas may exit from a sidewall 212 of the OTM device 200. In some examples, the first outlet port 206 is located downstream of the second outlet port 210.

FIG. 3 depicts layers of a membrane 300 of an OTM device, such as the membrane of OTM device 200. Membrane 300 includes a porous support 304, activation or catalytic layers 306 and 308, and a dense membrane 302. In operation, a feed gas 310 (also referred to as a retentate 310) contacts membrane 300 and dense membrane 302 facilitates the transport of ions (indicated by arrows 312 and 314) and the transport of electrons (indicated by arrows 316 and 318) such that ions are moved from the feed gas 310 to a sweep gas 320 (also referred to as permeate 320).

Dense membrane 302 is made of gas tight mixed ionic-electronic conductors 303A and electronic conductors 303B (collectively, MIEC 303). MIEC 303 allows for the simultaneous transport of oxygen via oxygen vacancies and electrons by small polaron hopping in the crystal lattice. In this way, dense membrane 302 produces a flux of pure oxygen based on the gradient between the partial pressure of oxygen on the two sides of the membrane. Membrane 300 functions at high temperatures (e.g., greater than about 500 degrees Celsius) because of the thermally activated diffusion process of oxygen ions. As a result, the permeation rate can be maximized through operating conditions (e.g., temperature, oxygen partial pressure gradients, and/or voltage differences), materials with optimized ambipolar diffusion, and reduction in the thickness of the membrane. The equation that represents this process is:

$${J}_{{O}_{2}} = \frac{R}{16 {F}^{2}} \frac{1}{L} {σ}_{amb} T ln \frac{{p O}_{2}^{feed}}{{p O}_{2}^{permeate}}$$

where R is the universal gnd/as constant, F is the Faraday constant, L is the thickness of the membrane, σ_{smb} is the ambipolar diffusion coefficient, T is the temperature at which the membrane is operated,

$${p O}_{2}^{feed}$$

is the partial oxygen pressure on the feed side of the membrane, and

$${p O}_{2}^{permeate}$$

is the pressure of oxygen on the permeated side of the membrane. To minimize the thickness of the membrane, a thick, porous support 304 may be used.

The thickness L of the membrane determines what mechanisms govern the permeation. The characteristic thickness L_{C} is defined by a ratio of self-diffusion coefficient (D_{S}) and surface exchange coefficient (k_{S}):

$${L}_{C} \frac{{D}_{S}}{{k}_{S}}$$

When the thickness L of the membrane is much smaller than L_{C} (L<<L_{C}), oxygen permeation is limited by surface-exchange kinetics. When L>>L_{C}, bulk diffusion is the main rate limiting factor.

Dense ceramic permeable membranes are capable of separating oxygen from an air flow intake with infinite permeation selectivity, resulting in over 99.9% of oxygen in permeated flow. For atmospheric composition approximated to ⅓ oxygen and ⅔ nitrogen, nitrogen purity values over 99.4% are achievable. Furthermore, ceramic membranes, such as Perovskite ceramics, have been shown to operate at feed pressures as low as 0.05 bar. Materials operable under low pressures may be required for certain applications where the inlet pressure to the cathode is low.

In some examples, permeation rate can be augmented by the application of a potential across the membrane as in the case of an electrochemical system. For example, application of a potential within a range from approximately 1 V to approximately 5V across the membrane may facilitate migration of selected gas constituents. such as oxygen, through the membrane. As such, when a pressure differential across the membrane or temperature of the membrane is not sufficient to drive a desired permeation, application of an electrical potential may enable satisfactory operation of an OTM.

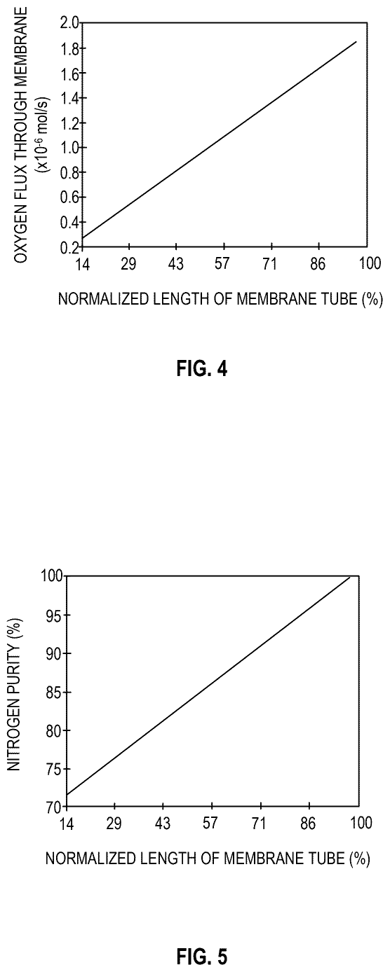

FIGS. 4 and 5 depict charts illustrating oxygen flux and nitrogen purity at a normalized length of a individual membrane tube. The correlations illustrated in FIGS. 4 and 5 may be used to determine the purity of nitrogen in the retentate. FIG. 4 depicts oxygen flux through an individual membrane tube having a radius of 1 millimeter (mm) and a wall thickness of 0.1 mm at 1000° C. with a feed to permeate ratio of about 0.1:0.03. As indicated by FIG. 4, oxygen flux increases linearly along the length of the membrane.

Assuming a permeated oxygen flux through the membrane J_{O}_{₂} of 0.008 moles per meter squared per second (mol/m²s) at 260 Torr, and a total exit flow rate of about 5 standard cubic centimeters per minute (sccm) or about 3.725·10⁻⁶ mol/s, the percent nitrogen purity C_{N}_{₂} may be calculated as

$${C}_{{N}_{2}} = ( 1 - \frac{{\dot{m}}_{{O}_{2} , out}}{{\dot{m}}_{total , out}} ) ( 100 ) with {\dot{m}}_{{O}_{2} , out} = {\dot{m}}_{{O}_{2} , in} - {AJ}_{{O}_{2}}$$

FIG. 5 depicts nitrogen purity from an element of the membrane of FIG. 4, i.e., having a radius of 1 mm and a wall thickness of 0.1 mm at 1000° C. with a feed to permeate ratio of about 0.1:0.03. As indicated by FIG. 5, nitrogen purity in the retentate increases linearly along the length of the membrane.

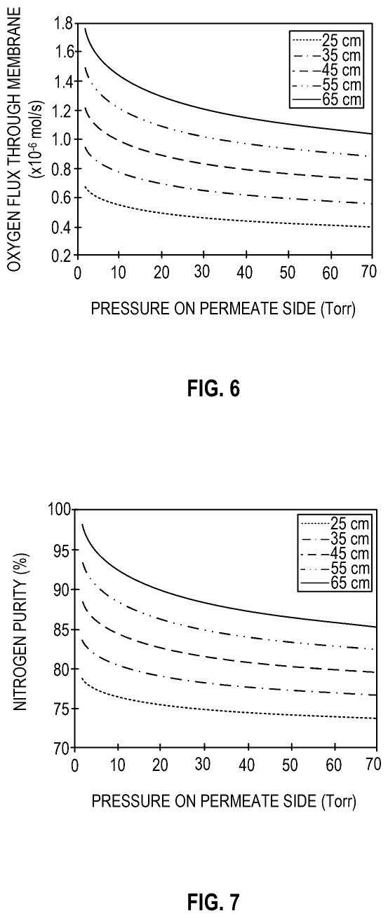

FIGS. 6 and 7 depict membrane performance as a function of pressure and length of the membrane tube. FIG. 6 depicts oxygen flux versus pressure on the permeate side through various lengths of membranes including a hollow tube having a radius of 1 mm and a wall thickness of 0.1 mm at 1000° C. FIG. 7 depicts nitrogen purity versus pressure on the permeate side through various lengths of membranes including a hollow tube having a radius of 1 mm and a wall thickness of 0.1 mm at 1000° C. As illustrated in FIGS. 6 and 7, the length of the membrane may be selected to provide a desired oxygen flux to the permeate and nitrogen purity in the retentate. Moreover, pressure and/or voltage on the permeate side may be controlled to provide the desired oxygen flux to the permeate and nitrogen purity in the retentate. In these ways, a dense ceramic permeable membrane can be selected to provide a desired permeation selectivity, retentate composition, permeate composition, or combinations thereof. For example, the dense ceramic permeable membrane may be selected to result in a permeation selectivity including 99.9% of oxygen in the permeate flow.

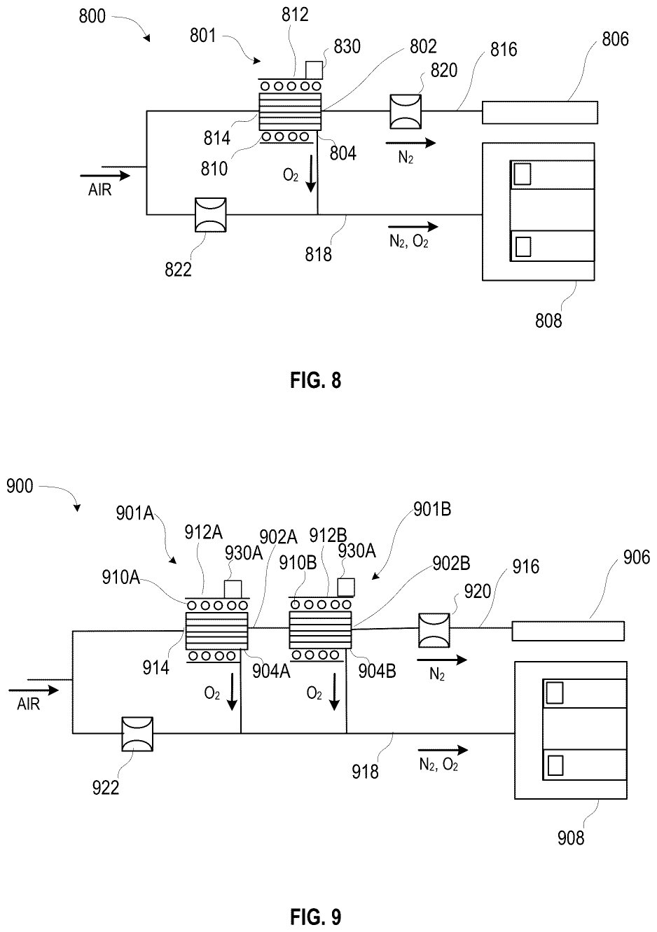

FIG. 8 depicts an electric thruster system 800. The electric thruster system 800 includes an OTM 801, a thermionic cathode 806, and a HET 808. OTM 801 may be the same as or substantially similar to OTM device 200 described above in reference to FIG. 2. For example, OTM 801 may include a dense ceramic permeable membrane.

OTM 801 includes a feed gas inlet 814, a retentate outlet 802, and a permeate outlet 804. OTM 801 also includes a heater element 810 and a thermal radiation shield 812 wrapped around the dense ceramic permeable membrane and an optional electric potential generator 830.

Heater element 810 and thermal radiation shield 812 are configured to heat the dense ceramic permeable membrane to a selected operating temperature. In some examples, the selected operating temperature may be within a range from approximately 500° C. to approximately 1300° C., such as approximately 1000° C. to approximately 1273° C. The selected operating temperature is configured to produce a selected oxygen permeation rate, given a length of the dense ceramic permeable membrane, feed gas composition, and operating pressures of OTM 801.

Optional electric potential generator 830 is configured to generate an applied voltage between the feed gas and permeate outlet. In some examples, the voltage potential may be within a range from approximately 1 V to approximately 5V. The selected voltage is configured to produce a selected oxygen permeation rate, given a length of the dense ceramic permeable membrane, feed gas composition, and operating pressures and temperature of OTM 801.

The feed gas inlet 814 includes one or more fluid streams through which the feed gas, e.g., air, is directed. The feed gas is separated into a retentate and a permeate via OTM 801. The retentate outlet 802 includes an oxygen depleted gas stream. The oxygen depleted gas stream is directed via oxygen depleted gas line 816 (also referred to as the cathode feedline 816) to cathode 806. The permeate outlet 804 includes an oxygen rich gas stream. The oxygen rich gas stream is directed via oxygen rich gas line 818 (also referred to as the thruster feedline 818) to HET 808. With air as the primary feed gas, such as during operation in VLEO, this oxygen depleted feed gas consists mostly of nitrogen, which is safe for thermionic cathode operation.

A first flow control orifice 820 and a second flow control orifice 822 (collectively, orifices 820, 822) are positioned to facilitate a selected flow split between cathode 806 and anode 808 and a selected pressure gradient for oxygen permeation across the OTM 801. For example, first flow control orifice 820 is positioned in cathode feedline 816 downstream of OTM 801. Second flow control orifice 822 is positioned in thruster feedline 818 upstream of the point where the oxygen rich gas is removed from OTM 801. As such, for a given pressure of the feed gas line 814, orifices 820, 822 may be controlled to provide a selected pressure in cathode feedline 816 and a selected pressure in thruster feedline 818.

In other examples, rather than orifices 820, 822, system 800 may include a pump upstream of cathode feedline 816 only or upstream of both cathode feedline 816 and thruster feedline 818. The pump may be used to achieve higher inlet pressures into OTM 801.

In some examples, an electric thruster system may include a plurality of OTMs configured to provide a selected gas feed composition to one or more cathodes and one or more thrusters. FIG. 9 is a conceptual diagram illustrating an example electric thruster system 900. Electric thruster system 900 may be the same as or substantially similar to electric thruster system 800 described above in reference to FIG. 8, except for the differences described herein. For example, electric thruster system 900 includes a first OTM 9011A and a second OTM 901B in series (collectively, OTMs 901).

OTM 901A has a feed gas inlet 914, a retentate outlet 902A, and a permeate outlet 904A. OTM 901B receives as a feed inlet retentate outlet 902A and has a retentate outlet 902B, and a permeate outlet 904B. An oxygen rich gas stream 918, as regulated at least in part by first flow control orifice 922, is directed to HET 908. An oxygen depleted gas stream 916, as regulated at least in part by second flow orifice 920, is directed to cathode 906. By using two OTMs 901, electric thruster system 900 is configured to provide higher gas purity levels for cathode feedline 916, selective separation of specific components of feed gas, such as air, including but not limited to oxygen, diatomic nitrogen, nitrogen dioxide, carbon dioxide, or the like, for other propellants that contain these compounds, compared to systems having only a single OTM.

Electric thruster system 900 may include heaters 910A and 910B, each with insulation 912A and 91213, and each associated with a respective OTM 901. Additionally, or alternatively, electric thruster system 900 may include one or more electric potential generators 930A and 930B associated with respective OTMs 901.

In some examples, first OTM 901A and second OTM 901B may include the same or substantially similar membrane, design, or both. In other examples, first OTM 901A and second OTM 9011B may include different membranes or designs, such as different dense ceramic membranes, each configured to have a selected permeation of selected gases. In this way, electric thruster system 900 may be configured to provide a selected cathode feed gas composition, a selected thruster feed gas composition, or both.

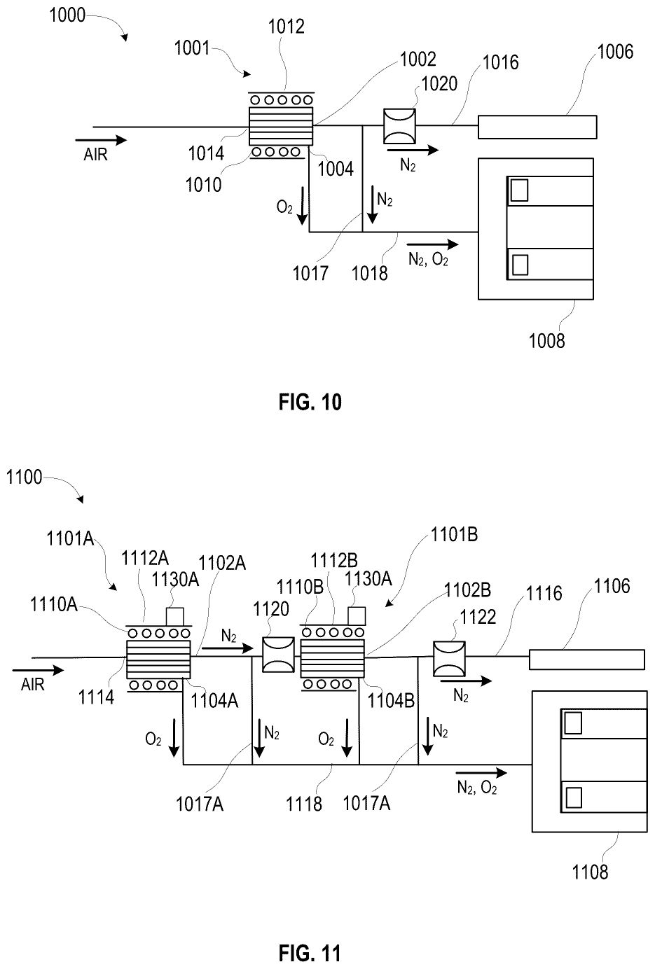

In some examples, the design of the electronic thruster system may be simplified by excluding the flow orifice on the oxygen rich gas stream. FIG. 10 is a is a conceptual diagram illustrating an example electric thruster system 1000. Electric thruster system 1000 may be the same as or substantially similar to electric thruster system 800 described above in reference to FIG. 8, except for the differences described herein, Specifically, oxygen rich gas stream 1018 is regulated by the flow of retentate outlet 1002 and flow orifice 1020.

Electric thruster system 1000 includes OTM 1001 having a feed gas inlet 1014, a retentate outlet 1002, and a permeate outlet 1004. An oxygen rich gas stream 1018, as regulated at least in part by gas flow in retentate outlet 1002 and optional flow control orifice 1020, is directed to HET 1008. An oxygen depleted gas stream 1016, may be regulated at least in part by optional flow orifice 1020, is directed to cathode 1006. Because the mass flow of retentate outlet 1002 is much greater than the mass flow of permeate outlet 1004, nitrogen from the retentate outlet 1002 may naturally flow to oxygen rich gas stream 1018, e.g., via line 1017. Optionally, line 1017 may include a valve or a flow orifice to control the flow of nitrogen from retentate outlet 1002 to oxygen rich gas stream 1018. Optionally, electric thruster system 1000 may exclude optional flow control orifice 1020.

In some examples, electric thruster system 1000 may include heater 1010 having insulation 1012. Additionally, or alternatively, electric thruster system 1000 may include one or more electric potential generators 1030.

In some examples, the simplified configuration illustrated in FIG. 10 may be implemented with two or more OTMs. FIG. 1I is a conceptual diagram illustrating an example electric thruster system 1100. Electric thruster system 1100 may be the same as or substantially similar to electric thruster systems 900 and 1000 described above in reference to FIGS. 9 and 10, except for the differences described herein. For example, electric thruster system 1100 includes a first OTM 1101A and a second OTM 1101B in series (collectively, OTMs 1101) and oxygen rich gas stream 1118 is regulated by the flow of retentate outlets 1102A and 1102B as well as flow orifice 1120.

OTM 1101A has a feed gas inlet 1114, a retentate outlet 1102A, and a permeate outlet 1104A. OTM 1101B receives a feed from retentate outlet 1102A and has a retentate outlet 1102B and a permeate outlet 1104B. An oxygen rich gas stream 1118, as regulated at least in part by gas flow retentate outlets 1102A and 1102B as well as optional first flow control orifices 1120 and/or optional second flow control orifice 1122, is directed to HET 1108. Because flow through oxygen rich gas stream 1118 may be regulated by pressure drop across OTMs 1101 and/or mass flow rate in retentate outlets 1102A and 1102B, in some examples, electronic thruster system 1100 may exclude one or both of first flow control orifice 1120 and second flow control orifice 1122. An oxygen depleted gas stream 1116, as regulated at least in part by flow orifice 1120, is directed to cathode 1106. By using two OTMs 1101, electric thruster system 1100 is configured to provide higher gas purity levels for cathode feedline 1116, selective separation of specific components of feed gas, such as air, including but not limited to oxygen, diatomic nitrogen, nitrogen dioxide, carbon dioxide, or the like, for other propellants that contain these compounds, compared to systems having only a single OTM.

Electric thruster system 1100 may include heaters 1110A and 1110B, each with respective insulation 1112A and 1112B, and each associated with a respective OTM 1101. Additionally, or alternatively, electric thruster system 1100 may include one or more electric potential generators 1130A and 1130B associated with respective OTMs 1101.

In some examples, first OTM 1101A and second OTM 1101B may be the same or substantially similar membrane or design. In other examples, first OTM 1101A and second OTM 1101B may include different membranes or designs, such as different dense ceramic membranes, each configured to have a selected permeation of selected gases. In this way, electric thruster system 1100 may be configured to provide a selected cathode feed gas composition, a selected thruster feed gas composition, or both.

In some examples, the thermionic material for the cathode includes lanthanum hexaboride. Compared to other thermionic materials, lanthanum hexaboride may have a higher tolerance to small traces of oxygen. Additionally, lanthanum hexaboride cathodes may not require conditioning or activation procedures. Moreover, lanthanum hexaboride cathodes have a similar geometry to conventional space dispenser hollow cathodes.

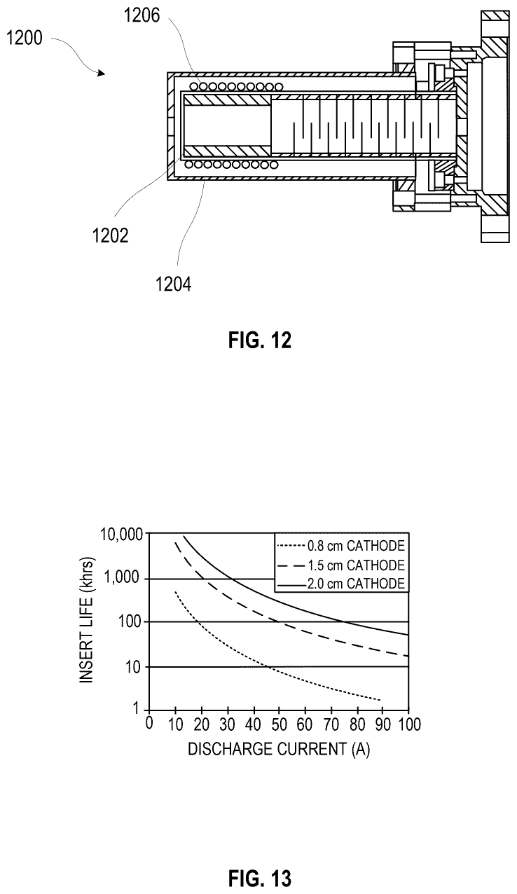

FIG. 12 is a conceptual diagram illustrating an example cathode 1200 having a thermionic insert 1202 including lanthanum hexaboride. Thermionic insert 1202 is positioned within a cathode tube 1204 and surrounded by a heating system 1206. Heating system 1206 may include one or more heating elements and one or more heat shields. In some examples, cathode 1200 includes an all-carbon geometry (e.g., insert and hollow tube made of graphite), further reducing material compatibility issues.

At 1570° C., lanthanum hexaboride can withstand oxygen partial pressure up to 10¹ Torr without degradation in the electron emission. Lifetimes of tens of thousands of hours (excess of 10 years) are achievable as shown in FIG. 13. FIG. 13 depicts insert life in kilohours versus discharge current in amps of lanthanum hexaboride cathode having different lengths. For example, a lanthanum hexaboride cathode with a length of 0.8 centimeters (cm) may achieve a insert life of at least 100 kilohours as currents below about 20 A; a lanthanum hexaboride cathode with a length of 1.5 cm may achieve a insert life of at least 1,000 kilohours as currents below about 20 A; and a lanthanum hexaboride cathode with a length of 2.0 cm may achieve a insert life of at least 1,000 kilohours as currents below about 30 A.

The examples above are illustrative and not limiting. Additional embodiments are within the claims. In addition, although the present disclosure has been described with reference to particular examples, those skilled in the art will recognize that changes can be made in form and detail without departing from the spirit and scope of the invention. Any incorporation by reference of documents above is limited such that no subject matter is incorporated, which is contrary to the explicit disclosure herein. To the extent that specific structures, compositions and/or processes are described herein with components, elements, ingredients or other partitions, it is to be understood that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

1. An electric thruster for operation in a very low Earth orbit (VLEO), comprising:
an oxygen transport membrane having an inlet configured to receive a feed gas comprising oxygen and nitrogen, an oxygen rich outlet, and an oxygen depleted outlet;
a cathode fluidly coupled by a cathode feedline to the oxygen depleted outlet and configured to receive an oxygen depleted gas stream; and
a thruster fluidly coupled by a thruster feedline to the oxygen rich outlet and configured to receive an oxygen rich gas stream.

2. The electric thruster of claim 1, further comprising:
a first flow control orifice fluidly coupled to the cathode feedline downstream of the oxygen transport membrane; and
a second flow control orifice fluidly coupled to the thruster feedline upstream of the oxygen depleted outlet.

3. The electric thruster of claim 1, further comprising a heater element configured to heat the oxygen transport membrane to a selected operating temperature.

4. The electric thruster of claim 3, wherein the heater element is configured to raise the selected operating temperature of the oxygen transport membrane to a temperature above at least 500° C.

5. The electric thruster of claim 3, wherein the heater element comprises a magnesium oxide mineral insulated cable heater system, and wherein the oxygen transport membrane is wrapped in a thermal shield.

6. The electric thruster of claim 1, further comprising an electric potential generator configured to produce across the oxygen transport membrane an electric voltage within a range from approximately 1 volt (V) to approximately 5 V, and wherein the electric voltage is configured to increase an electro-migration rate of oxygen across the membrane.

7. The electric thruster of claim 1, wherein the cathode comprises lanthanum hexaboride.

8. The electric thruster of claim 1, wherein the oxygen depleted gas stream contains less than 1% oxygen.

9. The electric thruster of claim 1, wherein the oxygen transport membrane comprises a ceramic permeable membrane.

10. The electric thruster of claim 9, wherein the ceramic is Perovskite ceramic.

11. The electric thruster of claim 1, wherein the oxygen transport membrane comprises:
a first oxygen transport membrane having the inlet configured to receive the feed gas, a first oxygen rich outlet, and a first oxygen depleted outlet; and
a second oxygen transport membrane having a second inlet fluidly coupled to the first oxygen depleted outlet of the first oxygen transport membrane, a second oxygen rich outlet, and the oxygen depleted outlet,
wherein the oxygen rich outlet comprises at least one of the first oxygen rich outlet of the first oxygen transport membrane and the second oxygen rich outlet of the second oxygen transport membrane.

12. A compound transport membrane for an ion propulsion system having a cathode and an anode, comprising:
a membrane having a stable ionic conductor and a stable electronic conductor within a crystalline ceramic matrix;
an input end for receiving a feed gas comprising oxygen and nitrogen;
an output end opposite the input end, the output end comprising:
a first orifice fluidly coupled to the cathode of the ion propulsion system; and
a second orifice fluidly coupled to the anode of the ion propulsion system,
wherein the first orifice and the second orifice are positioned to generate a predetermined pressure gradient to allow the compound to permeate across the membrane, and wherein the first orifice being positioned downstream from the second orifice.

13. The compound transport membrane of claim 12, wherein the compound is one of oxygen, nitrogen, or carbon dioxide.

14. The compound transport membrane of claim 12, wherein the feed gas is atmospheric air comprising approximately one-third oxygen and two-thirds nitrogen, and wherein more than 99% of the oxygen permeates across the membrane.

15. The compound transport membrane of claim 12, wherein the compound transport membrane is connected to a second compound transport membrane, the second compound transport membrane configured to remove a second, different compound of the feed gas.

16. The compound transport membrane of claim 12, wherein the anode comprises the thruster of an electric thruster for operation in a very low Earth orbit (VLEO).

17. A method of operating an electric thruster having a thermionic cathode in an oxygen rich environment, wherein the method comprises:
drawing air from the oxygen rich environment into an oxygen transport membrane;
separating, by the oxygen transport membrane, the air into an oxygen rich gas and an oxygen depleted gas; and
routing the oxygen depleted gas to the thermionic cathode.

18. The method of claim 17, wherein the method further comprises routing the oxygen rich gas to at least one of a hall effect thruster, a gridded ion thruster, and a magneto-plasma dynamic thruster.

19. The method of claim 17, wherein the method further comprises heating the oxygen transport membrane to above at least 500° C.

20. The method of claim 17, wherein the method further comprises applying a voltage across the oxygen transport membrane of approximately 1 volts (V) to approximately 5V.
